(19) United States
(12) Patent Application Publication
(10) Pub. No.: US 2025/0086676 A1
(43) Pub. Date: Mar. 13, 2025

(54) PERSONA-DRIVEN AUTOMATED CONTENT ENGAGEMENT SYSTEM

(71) Applicant: Capital One Services, LLC, McLean, VA (US)

(72) Inventor: Bryan TAMAYO, Allen, TX (US)

(21) Appl. No.: 18/462,736

(22) Filed: Sep. 7, 2023

(51) Int. Cl. G06Q 30/0251; G06F 16/2457; G06F 16/9535

(52) U.S. Cl. CPC G06Q 30/0271; G06F 16/24578; G06F 16/9535

(57) ABSTRACT

In some implementations, a content hosting system may receive a content item that includes one or more interactive elements associated with a plurality of user personas that each include shared attributes associated with a user group. The content hosting system may serve the content item to a user device based on a request to access the content item. The content hosting system may track engagement data related to a content consumer associated with the user device engaging with the content item and/or the one or more interactive elements. The content hosting system may identify, among the plurality of user personas, a user persona associated with the content consumer associated with the user device based on the engagement data. The content hosting system may adapt a layout associated with the content item based on the user persona associated with the content consumer associated with the user device.

### BACKGROUND

Content authoring systems are software platforms that facilitate the creation, management, and/or publication of digital content, typically for websites, e-learning courses, documentation, and/or other digital media. Content authoring systems are generally designed to simplify the content creation process by providing tools and features that allow users, often without extensive technical knowledge, to create and manage digital content efficiently.

### SUMMARY

Some implementations described herein relate to a system for persona-driven automated content engagement. The system may include one or more memories and one or more processors communicatively coupled to the one or more memories. The one or more processors may be configured to receive, from a first user device associated with a content author, a content item that includes one or more interactive elements, wherein the content item and the one or more interactive elements are associated with a plurality of user personas that each include shared attributes associated with a user group, and wherein the plurality of user personas associated with the content item and the one or more interactive elements are defined by the content author. The one or more processors may be configured to serve, to a second user device associated with a content consumer, the content item based on a request to access the content item. The one or more processors may be configured to track engagement data that relates to the content consumer associated with the second user device engaging with one or more of the content item or the one or more interactive elements included in the content item. The one or more processors may be configured to identify, among the plurality of user personas associated with the content item and the one or more interactive elements, a user persona associated with the content consumer associated with the second user device based on the engagement data. The one or more processors may be configured to adapt a layout associated with the content item based on the user persona associated with the content consumer associated with the second user device.

Some implementations described herein relate to a method for persona-driven automated content engagement. The method may include receiving, by a content hosting system and from a first user device associated with a content author, a content item that includes one or more interactive elements, wherein the content item and the one or more interactive elements are associated with a plurality of user personas that each include shared attributes associated with a user group. The method may include serving, by the content hosting system, to a second user device associated with a content consumer, the content item based on a request to access the content item. The method may include tracking, by the content hosting system, engagement data that relates to the content consumer associated with the second user device engaging with one or more of the content item or the one or more interactive elements included in the content item. The method may include identifying, by the content hosting system, among the plurality of user personas associated with the content item and the one or more interactive elements, a user persona associated with the content consumer associated with the second user device based on the engagement data. The method may include adapting, by the content hosting system, a layout associated with the content item based on the user persona associated with the content consumer associated with the second user device.

Some implementations described herein relate to a non-transitory computer-readable medium that stores a set of instructions. The set of instructions, when executed by one or more processors of a content hosting system, may cause the content hosting system to receive, from a first user device associated with a content author, a content item that includes one or more interactive elements, wherein the content item and the one or more interactive elements are associated with a plurality of user personas that each include shared attributes associated with a user group. The set of instructions, when executed by one or more processors of the content hosting system, may cause the content hosting system to serve, to a second user device associated with a content consumer, the content item based on a request to access the content item. The set of instructions, when executed by one or more processors of the content hosting system, may cause the content hosting system to track engagement data that relates to the content consumer associated with the second user device engaging with one or more of the content item or the one or more interactive elements included in the content item. The set of instructions, when executed by one or more processors of the content hosting system, may cause the content hosting system to identify, among the plurality of user personas associated with the content item and the one or more interactive elements, a user persona associated with the content consumer associated with the second user device based on the engagement data. The set of instructions, when executed by one or more processors of the content hosting system, may cause the content hosting system to select targeted content based on the shared attributes associated with the user group that corresponds to the user persona associated with the content consumer. The set of instructions, when executed by one or more processors of the content hosting system, may cause the content hosting system to serve the targeted content to the second user device.

### BRIEF DESCRIPTION OF THE DRAWINGS

FIGS. 1A-1C are diagrams of an example associated with persona-driven content engagement, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIG. 4 is a flowchart of an example process associated with persona-driven content engagement, in accordance with some embodiments of the present disclosure.

### DETAILED DESCRIPTION

The following detailed description of example implementations refers to the accompanying drawings. The same reference numbers in different drawings may identify the same or similar elements.

Personalized content delivery generally involves techniques to tailor content and the presentation of content to specific user preferences, behaviors, and/or characteristics. For example, one approach to personalize content delivery may include user profiling, where user data such as browsing histories, preferences, and/or demographic information is collected and analyzed to create detailed user profiles that are then used to tailor content recommendations. Another approach to personalize content delivery may include behavioral tracking (e.g., tracking clicks, likes, shares, and/or other user interactions to recommend related content), collaborative filtering (e.g., analyzing user behavior and preferences to identify patterns and recommend content that similar users may have found interesting), content-based filtering (e.g., analyzing characteristics of the content itself, such as keywords, topics, and genres, to recommend similar content to users who have shown interest in related topics), and/or using machine learning algorithms to predict user interests and preferences. However, techniques that are typically used to personalize content delivery (e.g., using cookies and other tracking methods and/or machine learning algorithms) tend to be inefficient, because the existing techniques often result in inaccurate recommendations, excessive data collection, privacy concerns, and/or difficulties maintaining consistent user experiences across different devices and platforms. In addition, overreliance on algorithms can lead to a lack of a human touch and understanding, resulting in supposedly personalized content that feels overly automated and impersonal.

Accordingly, content personalization systems are associated with various problems and/or challenges, including incomplete, outdated, or biased data resulting in inaccurate content personalization results (e.g., causing unnecessary or wasted resource consumption related to loading and/or consumption of the inaccurate content personalization results and/or a user having to search for more relevant content). In addition, content personalization systems are subject to a cold start problem, where providing accurate personalized content recommendations may be challenging when a user is new to a content platform or has a limited interaction history. Additional problems with content personalization systems include algorithmic bias, where personalization algorithms could potentially reinforce biases present in training data and provide biased recommendations that reinforce stereotypes or exclude certain groups, scalability problems due to the need to handle increasing data volumes and provide real-time recommendations that may strain an underlying infrastructure as a user base grows, and/or privacy concerns related to collecting user data, among other examples.

Some implementations described herein relate to a content hosting system that may perform automated persona-driven content classification and content delivery with interaction tracking. For example, in some implementations, the content hosting system may allow content authors to define one or more personas to associate with authored content items created by the content authors, and the persona-driven content hosting system may score content items and/or interactive content elements included in the content items based on a likelihood that users associated with each persona will engage (e.g., view or interact with) the content items and/or interactive content elements. Accordingly, as described herein, content authors may generate content items and interactive content elements that cater to different author-defined personas, which may be defined in one or more data structures or objects to represent a specific group of users that share common characteristics, behaviors, goals, and/or interests, among other examples (e.g., based on data elements that relate to demographics, psychographic details, user-related scenarios, or other user attributes). The content hosting system may then assign numeric ratings or scores to the content items and interactive elements based on the likelihood that users associated with each author-defined persona will engage with the content items and interactive elements, and may track or otherwise record user views of the content items and/or interactions with the various interactive content elements. Accordingly, based on engagement data related to the tracked user views of the content items and/or interactions with the various interactive content elements, the content hosting system may calculate average scores for each author-defined persona and identify a persona to associate with a user based on the author-defined persona with the highest average score. In some implementations, the content hosting system may then adjust a layout of the content items based on the persona associated with the user, and may also serve targeted content (e.g., advertisements) to the user within a range of interests associated with the persona associated with the user. Additionally, or alternatively, the persona associated with the user may incorporate one or more machine learning algorithms to improve the accuracy of identifying a user persona, may use natural language processing techniques to score text-based content items more effectively, and/or may integrate social media data for more comprehensive user profiling and/or persona identification.

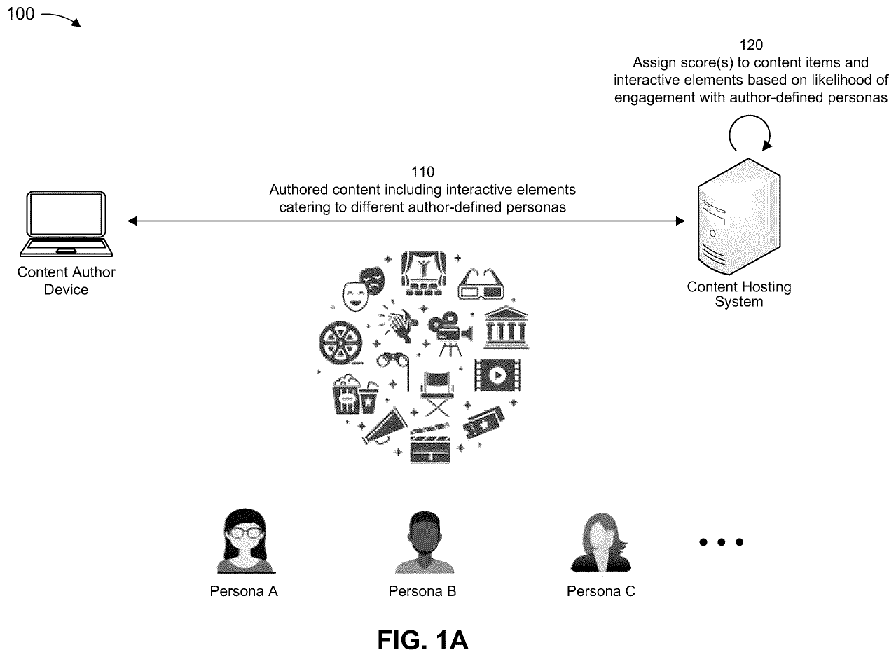

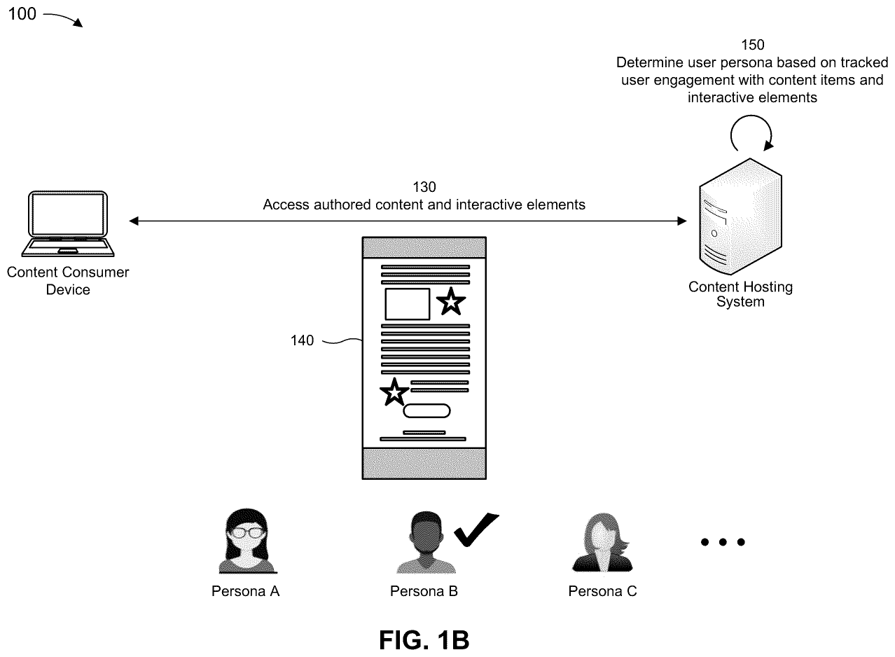

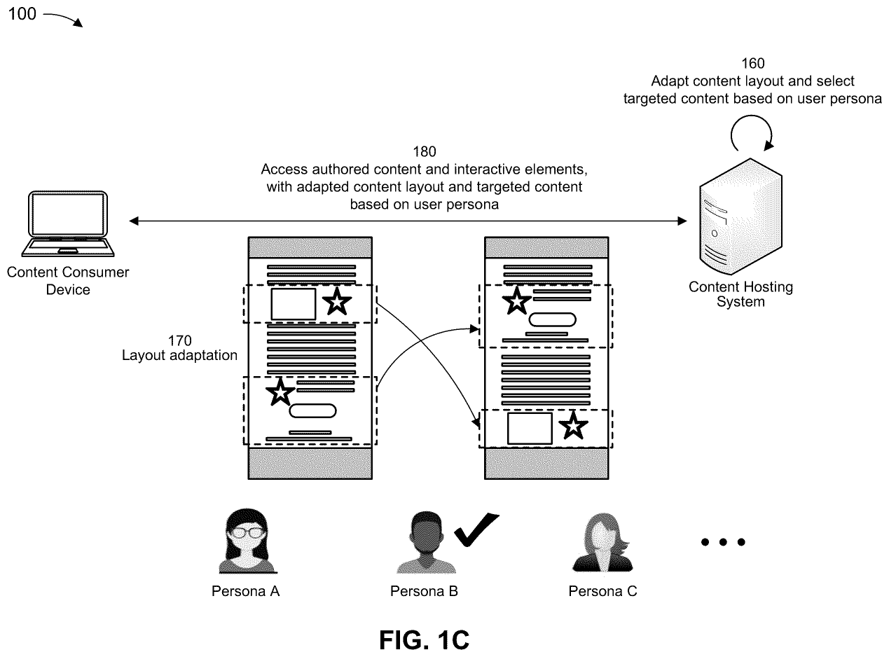

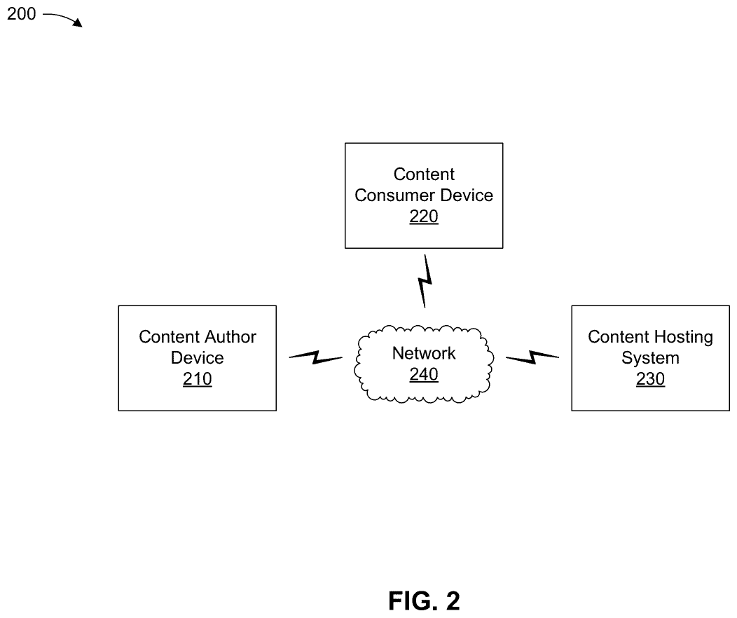

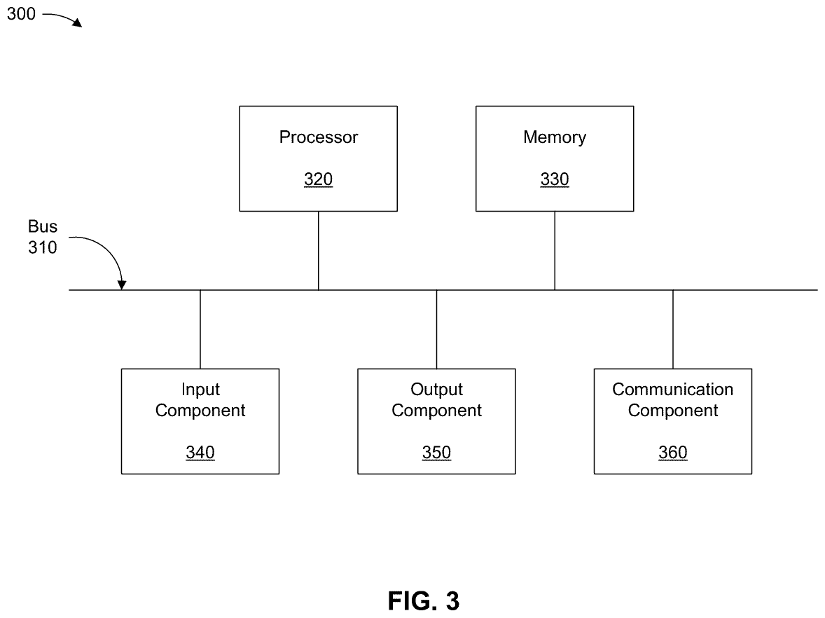

FIGS. 1A-1C are diagrams of an example 100 associated with persona-driven automated content engagement. As shown in FIGS. 1A-1C, example 100 includes a content author device, a content consumer device, and a content hosting system. The content author device, the content consumer device, and the content hosting system are described in more detail in connection with FIG. 2 and FIG. 3.

As shown in FIG. 1A, and by reference number 110, the content hosting system may receive, from the content author device, a content item that includes one or more interactive elements. For example, in some implementations, the content author device may be operated by a content author (e.g., a user who creates a content item) that interacts with the content hosting system to create the content item using a content creation module associated with the content hosting system. For example, in some implementations, the content creation module may facilitate the creation, management, and publication of digital content, which may include website content, blog posts, e-learning materials, documentation, and/or any other suitable digital media (e.g., text-based content, audio-based content, image-based content, video-based content, and/or any suitable combination thereof). In some implementations, the content creation module may include or may support various tools and/or features to enable the content author operating the content author device to create and manage digital content items. For example, in some implementations, the content creation module may provide user-friendly interfaces (e.g., menus, toolbars, drag-and-drop functionality, and/or other intuitive elements) that allow the content author to interact with the content hosting system without having to write code. Furthermore, in some implementations, the content creation module may support a WYSIWIG (What You See Is What You Get) editor that allows the content author to create and edit content items in a manner that closely resembles how the content items will appear to content consumers (e.g., using rich text formatting, media insertion, and/or other multimedia elements), may provide templates and themes that allow the content author to create content items starting from predefined layouts, and/or may support multimedia integration (e.g., to add multimedia elements such as images, videos, audio files, animations, and/or interactive components, some of which may be stored in built-in media libraries), among other examples.

Accordingly, as described herein, the content author associated with the content author device may interact with the content creation module of the content hosting system to generate one or more content items, which may include one or more interactive elements. Additionally, or alternatively, the content author may generate the content items using a separate content authoring platform that runs on the content author device or a different system or device. In either case, the content author may interact with the content creation module provided by the content hosting system to define one or more user personas to associate with the content item(s) provided to the content hosting system and/or the interactive elements included in the content item(s) provided to the content hosting system. For example, in some implementations, a user persona may be defined within a data structure or an object based on information that represents a specific group of users that share certain attributes, such as demographic information, psychographic details, and/or user-related scenarios.

For example, the demographic information included in a persona data structure or object may encompass various key characteristics associated with a group of users, such as age, gender, location, education, and/or occupation, among other examples of demographic information that may provide a snapshot into a basic background associated with the persona. For instance, in designing a content item, knowing whether the content item is intended to cater to a tech-savvy teenager persona or a middle-aged professional persona can greatly influence the interactive elements, layout, and/or other details related to how a content consumer is expected to engage with the content item. Furthermore, in some implementations, the psychographic details included in a persona data structure or object may delve deeper into the personality traits, values, interests, pain points, and/or other attributes shared by members of the group of users associated with the persona. For example, the psychographic details may provide insights into the motivations and preferences of the user persona, which may aid in tailoring the content item(s) and/or interactive elements to resonate effectively (e.g., understanding whether the persona is environmentally conscious or tech-adverse can inform design choices and/or content layout strategies). Furthermore, in some implementations, the user-related scenarios associated with a persona data structure or object may describe specific scenarios or use cases in which the persona would interact with a content item or an interactive element included in a content item. For example, the user-related scenarios may offer a tangible context for content design decisions by illustrating how the persona might engage with the content item or an interactive element in real-life situations (e.g., by describing scenarios that anticipate needs and challenges of content consumers). For instance, if designing a content item related to e-commerce, the user-related scenarios may include tasks such as browsing products, making purchases, and/or tracking orders. Accordingly, as described herein, a persona data structure or object may generally combine demographic information, psychographic insights, user-related scenarios, and/or any other information that may be used to provide understanding and empathy with a particular user group such that content authors can create content items providing user-centric experiences that effectively address the needs, desires, and preferences of a target audience.

Accordingly, in some implementations, the content hosting system may receive, from the content author device, an authored content item that includes one or more interactive elements, which the content author may associate with a plurality of user personas that each include shared attributes associated with a respective user group. For example, in some implementations, the user personas may include any suitable combination of the user persona information described in more detail elsewhere herein. In some implementations, the user personas may be defined by content authors based on research performed by the content authors. For example, in some implementations, content authors may use an interface provided by the content creation module to define the various attributes that are shared by users associated with a particular persona. Additionally, or alternatively, the content creation module may store information related to previously defined user personas and/or a default set of user personas, and content authors may select one or more of the previously defined and/or default user personas to associate with the content item and/or interactive elements of a content item. In this way, content authors may select user personas from a library of user personas, and/or may define or more custom user personas to add to the library of user personas, where the selected and/or defined user personas may relate to different groups of users that the content author expects will engage with the content item and/or the interactive elements of the content item.

As further shown in FIG. 1A, and by reference number 120, the content hosting system may assign a score to the content item provided by the content author device and/or may assign respective scores to the interactive elements included in the content item. For example, in some implementations, the content hosting system may include a content scoring module that assigns the scores to the content item and/or the interactive elements included in the content item based on a likelihood that users associated with each persona will engage with the content item and/or the interactive elements included in the content item. For example, as described herein, each content item may include one or more media elements, such as text, images, animations, audio, video, and/or any suitable combination thereof, which may be arranged according to a particular layout. Accordingly, the content scoring module may assign a score to the content item based on a likelihood that users associated with each persona will engage with the content item, and/or may assign respective scores to each interactive element individually based on a likelihood that users associated with each persona will engage with each interactive element. In some implementations, the scores that are assigned to the content items and the interactive elements associated with the content items may be within a suitable numeric range (e.g., from 1 to 4 or another suitable range), with higher values indicating a relatively higher likelihood of engagement and lower values indicating a relatively lower likelihood of engagement.

Additionally, or alternatively, the scores that are assigned to the content items and the interactive elements associated with the content items may be associated with non-numeric values (e.g., high, medium, low, or the like). Additionally, or alternatively, in some implementations, the content scoring module may use natural language processing techniques to understand the meaning or intent associated with one or more content items or interactive elements (e.g., text-based content elements, including passages of text, text descriptions or transcriptions of audio or video content, or the like), and the score assigned to the content item and/or interactive elements may be based on the meaning or intent of the one or more content items or interactive elements.

As shown in FIG. 1B, and by reference number 130, the content hosting system may serve a content item stored by or otherwise available via the content hosting system to a content consumer device that is associated with (e.g., operated by) a content consumer. For example, as described herein, the content hosting system may host various authored content items, which the content consumer (e.g., a user operating the content consumer device) may request to access via any suitable channel. For example, in some implementations, the content hosting system may provide an interface that allows the content consumer device to access the hosted content items (e.g., via a website, mobile application, or the like), or the content hosting system may interface with one or more third party devices that provide access to the content items hosted by the content hosting system. In some implementations, as shown by reference number 140, the content item that is served to the content consumer device may include website content, blog posts, e-learning materials, documentation, and/or any other suitable digital media (e.g., text-based content, audio-based content, image-based content, video-based content, animations, and/or any suitable combination thereof). Furthermore, as shown by reference number 140, the various interactive elements (e.g., text-based content, audio-based content, image-based content, video-based content, and/or animations) may be organized according to a layout that defines locations within a page where the various interactive elements are displayed. Furthermore, as described herein, the content item that is served to the content consumer device and/or the interactive elements making up the content item may be designed (e.g., by the content author) to cater to various different user personas, and the content item and the interactive elements making up the content item may be associated with respective scores that are based on a likelihood or probability of a user associated with each persona engaging with (e.g., viewing) the content item and/or engaging with (e.g., interacting with) the interactive elements making up the content item.

As further shown in FIG. 1B, and by reference number 150, the content hosting system may determine a user persona to associate with the content consumer (e.g., user) associated with the content consumer device. For example, when the content consumer initially accesses a content item hosted by the content hosting system, the content hosting system may have little or no information regarding the demographics, psychographic details, preferences, behaviors, or other attributes associated with the user (e.g., similar to the cold start problem described elsewhere herein). Accordingly, the content hosting system may execute a user tracking module to record user views of the content items hosted by the content hosting system and user interactions with the various interactive content elements included in the hosted content items. For example, the user tracking module may be configured to track engagement data that relates to the content consumer associated with the content consumer device engaging with (e.g., viewing or interacting with) the content item or the interactive elements included in the content item that is served to the content consumer device. For example, the engagement data may include a count or other suitable metric that indicates how many times, how frequently, and/or how long the content consumer is views, interacts with, or otherwise engages the content item or the interactive elements included in the content item (e.g., based on scrolling events, mouseover or hover events, click or selection events, or the like).

In some implementations, the engagement data that is tracked by the user tracking module may be provided, as an input, to a persona identification module that may analyze the engagement data and calculate a score for each persona that is associated with the content item based on the engagement data. For example, as described herein, each content item and interactive content element is associated with multiple personas (e.g., author-defined personas), and the content scoring module may assign a score or rating to each content item and interactive content element based on a likelihood or probability of users associated with each of the multiple personas engaging with (e.g., viewing or otherwise interacting with) the content item and/or the interactive content elements included in the content item. Accordingly, when the content consumer associated with the content consumer device views the content item, performs one or more interactions with the content item or other interactive content elements, and/or otherwise engages with certain aspects of the content item, the corresponding engagement data may be input to the persona identification module along with the scores or ratings that were assigned to the content item and the interactive content elements to reflect the likelihood of engagement by users associated with the different personas. In this way, the persona identification module may obtain observations (e.g., from the engagement data) that indicate one or more aspects of the content item that the content consumer is engaging with and/or one or more aspects of the content item that the content consumer is not engaging with, which may be used to identify, among the various user personas associated with the content item and the interactive elements included in the content item, a user persona associated with the content consumer.

For example, in some implementations, the persona identification module may calculate average scores for each author-defined persona that is associated with the content item or an interactive element associated with the content item, where the average scores may each represent a probability of the content consumer being associated with a subset of the shared attributes associated with the corresponding user persona. Accordingly, the persona identification module may determine that the persona associated with a highest score is the persona of the content consumer. Additionally, or alternatively, the persona identification module may use one or more machine learning algorithms to identify the persona associated with the content consumer. For example, the one or more machine learning algorithms may be trained based on a set of historical observations that indicate engagement patterns associated with different user personas, and then the engagement data that relates to the tracked interactions associated with the content consumer may be input to the machine learning algorithm(s) as a new observation to classify the engagement data into a target user persona. Additionally, or alternatively, the persona identification may obtain or otherwise integrate social media data (e.g., data obtained from one or more social media platforms related to behaviors, preferences, likes, dislikes, interests, or other attributes) associated with the content consumer, and may take the social media data into consideration when identifying the persona of the content consumer.

As shown in FIG. 1C, and by reference number 160, the content hosting system may dynamically adapt a layout associated with the content item based on the user persona associated with the content consumer associated with the content consumer device. For example, the content hosting system may include a dynamic layout adaptation module configured to determine, for a current version of the layout associated with the content item, a probability of the content consumer interacting with the content item or certain interactive elements, and the dynamic layout adaptation module may then adjust the layout associated with the content item to place one or more interactive elements at locations that increase the probability of the content consumer interacting with the one or more interactive elements based on the shared attributes associated with the user group corresponding to the persona assigned to the content consumer. For example, FIG. 1C illustrates an example scenario where a content item is associated with three personas (e.g., that represent potential target audiences for the content item), shown as Persona A, Persona B, and Persona C, and the content consumer associated with the content consumer device is categorized within Persona B based on the engagement data indicating that the content consumer is engaging most with aspects of the content item that were designed to cater to users associated with Persona B. Accordingly, as shown by reference number 170, the dynamic layout adaptation module may adjust or otherwise adapt a layout of the content item for the content consumer associated with Persona B such that certain content elements that cater to users associated with Persona B are strategically featured more prominently and/or such that certain content elements that cater to users associated with Persona A or Persona C are strategically featured less prominently. Additionally, or alternatively, the layout of the content item may be adapted such content elements that cater to users associated with Persona B are strategically featured less prominently and/or such that certain content elements that cater to users associated with Persona A or Persona C are strategically featured more prominently in order to promote the users associated with Persona B engaging with different aspects of the content item that may otherwise receive less attention from users associated with Persona B.

As further shown in FIG. 1C, and by reference number 180, the content consumer associated with the content consumer device may then access the authored content item and the associated interactive elements via the content hosting system, and the authored content item may have a layout that is adapted based on the persona associated with the content consumer. Furthermore, in some implementations, the content hosting system may serve additional targeted content to the content consumer device (e.g., separate from or included within the content item) that is within a range of interests associated with the persona of the content consumer. For example, the targeted content may include one or more advertisements, recommendations for similar or related content items, and/or any other suitable content that is targeted to the user of the content consumer device based on the shared attributes associated with the user persona identified as being the persona of the content consumer. Furthermore, if and/or when the content consumer revisits the content hosting system to access a new content item or a previously viewed content item, the new content item or the previously viewed content item may be served to the content consumer device in accordance with the adjusted layout. For example, when the content hosting system receives a subsequent request to access the new content item or the previously viewed content item, the layout of the requested content item may be adjusted according to the persona that was previously associated with the content consumer. Furthermore, the content hosting system may continue to track new interactions with the content item(s) served to the content consumer device, and may rescore the engagement data related to the new interactions with the served content item(s) and continue to reclassify or otherwise update the persona associated with the content consumer and/or the manner in which content is tailored and/or targeted content is selected based on the current identified persona.

As indicated above, FIGS. 1A-1C are provided as an example. Other examples may differ from what is described with regard to FIGS. 1A-1C.

FIG. 2 is a diagram of an example environment 200 in which systems and/or methods described herein may be implemented. As shown in FIG. 2, environment 200 may include a content author device 210, a content consumer device 220, a content hosting system 230, and a network 240. Devices of environment 200 may interconnect via wired connections, wireless connections, or a combination of wired and wireless connections.

The content author device 210 may include one or more devices capable of receiving, generating, storing, processing, and/or providing information associated with persona-driven automated content engagement, as described elsewhere herein. The content author device 210 may include a communication device and/or a computing device. For example, the content author device 210 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The content consumer device 220 may include one or more devices capable of receiving, generating, storing, processing, and/or providing information associated with persona-driven automated content engagement, as described elsewhere herein. The content consumer device 220 may include a communication device and/or a computing device. For example, the content consumer device 220 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The content hosting system 230 may include one or more devices capable of receiving, generating, storing, processing, providing, and/or routing information associated with persona-driven automated content engagement, as described elsewhere herein. The content hosting system 230 may include a communication device and/or a computing device. For example, the content hosting system 230 may include a server, such as an application server, a client server, a web server, a database server, a host server, a proxy server, a virtual server (e.g., executing on computing hardware), or a server in a cloud computing system. In some implementations, the content hosting system 230 may include computing hardware used in a cloud computing environment.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with persona-driven automated content engagement. The device 300 may correspond to the content author device 210, the content consumer device 220, and/or the content hosting system 230. In some implementations, the content author device 210, the content consumer device 220, and/or the content hosting system 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection).

The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

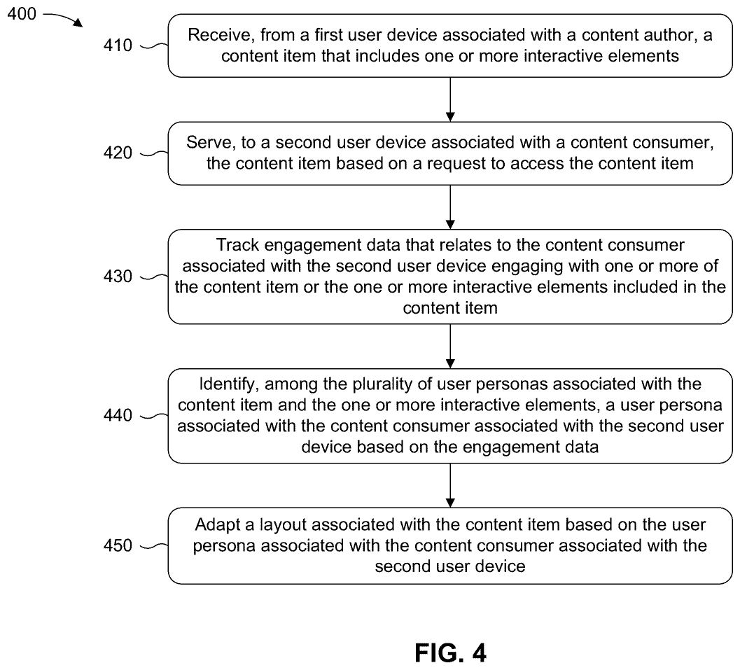

FIG. 4 is a flowchart of an example process 400 associated with persona-driven automated content engagement. In some implementations, one or more process blocks of FIG. 4 may be performed by the content hosting system 230. In some implementations, one or more process blocks of FIG. 4 may be performed by another device or a group of devices separate from or including the content hosting system 230, such as the content author device 210 and/or the content consumer device 220. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving, from a first user device associated with a content author, a content item that includes one or more interactive elements (block 410). For example, the content hosting system 230 (e.g., using processor 320, memory 330, input component 340, and/or communication component 360) may receive, from a first user device associated with a content author, a content item that includes one or more interactive elements, as described above in connection with reference number 110 of FIG. 1A. In some implementations, the content item and the one or more interactive elements are associated with a plurality of user personas that each include shared attributes associated with a user group. In some implementations, the plurality of user personas associated with the content item and the one or more interactive elements are defined by the content author. As an example, a content author may access the content hosting system via a suitable user device, and may interact with a content creation module to generate an authored content item that includes one or more interactive content elements catering to different user personas.

As further shown in FIG. 4, process 400 may include serving, to a second user device associated with a content consumer, the content item based on a request to access the content item (block 420). For example, the content hosting system 230 (e.g., using processor 320 and/or memory 330) may serve, to a second user device associated with a content consumer, the content item based on a request to access the content item, as described above in connection with reference number 130 of FIG. 1B. As an example, a content consumer may access the content hosting system via a suitable user device, and the content hosting system may serve an authored content item hosted by the content hosting system to the user device associated with the content consumer based on a request from the user device associated with the content consumer.

As further shown in FIG. 4, process 400 may include tracking engagement data that relates to the content consumer associated with the second user device engaging with one or more of the content item or the one or more interactive elements included in the content item (block 430). For example, the content hosting system 230 (e.g., using processor 320 and/or memory 330) may track engagement data that relates to the content consumer associated with the second user device engaging with one or more of the content item or the one or more interactive elements included in the content item, as described above in connection with reference numbers 130, 140, and 150 of FIG. 1B. As an example, while the content consumer is viewing and/or interacting with the content item, a user tracking module may track engagement data that relates to view events, scroll events, hover events, selection events, and/or other events that indicate how the content consumer is engaging with the content item, which aspects of the content item the content consumer is engaged with, or the like.

As further shown in FIG. 4, process 400 may include identifying, among the plurality of user personas associated with the content item and the one or more interactive elements, a user persona associated with the content consumer associated with the second user device based on the engagement data (block 440). For example, the content hosting system 230 (e.g., using processor 320 and/or memory 330) may identify, among the plurality of user personas associated with the content item and the one or more interactive elements, a user persona associated with the content consumer associated with the second user device based on the engagement data, as described above in connection with reference number 150 of FIG. 1B. As an example, an authored content item may be designed or may include one or more interactive content elements that are designed to cater to different user personas, and a content scoring module may assign ratings or scores to each content item and interactive element based on a likelihood or probability of engagement with the various author-defined personas. Furthermore, a user tracking module may track user engagement data, which may include user views and/or interactions with the content item or interactive content elements, and a persona identification module may analyze the engagement data and calculate an average score for each author-defined persona based on the engagement data and the ratings or scores assigned to the content item or interactive content elements. In this way, the persona identification module may identify, among the various author-defined personas associated with the content item served to the content consumer, a user persona to associate with the content consumer based on the engagement data.

As further shown in FIG. 4, process 400 may include adapting a layout associated with the content item based on the user persona associated with the content consumer associated with the second user device (block 450). For example, the content hosting system 230 (e.g., using processor 320 and/or memory 330) may adapt a layout associated with the content item based on the user persona associated with the content consumer associated with the second user device, as described above in connection with reference numbers 160 and 170 of FIG. 1C. As an example, a dynamic layout adaptation module may adapt a placement of one or more interactive content elements and/or may adapt which content elements to include or omit from the content item based on the persona associated with the content consumer (e.g., to increase or decrease the probability of the content consumer engaging with certain content elements).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1C. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for persona-driven automated content engagement, the system comprising:
one or more memories; and
one or more processors, communicatively coupled to the one or more memories, configured to:
receive, from a first user device associated with a content author, a content item that includes one or more interactive elements,
wherein the content item and the one or more interactive elements are associated with a plurality of user personas that each include shared attributes associated with a user group, and
wherein the plurality of user personas associated with the content item and the one or more interactive elements are defined by the content author;
serve, to a second user device associated with a content consumer, the content item based on a request to access the content item;
track engagement data that relates to the content consumer associated with the second user device engaging with one or more of the content item or the one or more interactive elements included in the content item;
identify, among the plurality of user personas associated with the content item and the one or more interactive elements, a user persona associated with the content consumer associated with the second user device based on the engagement data; and
adapt a layout associated with the content item based on the user persona associated with the content consumer associated with the second user device.

2. The system of claim 1, wherein the one or more processors are further configured to:
assign, for each of the plurality of user personas, a respective score to the content item and respective scores to the one or more interactive elements included in the content item based on probabilities of users in the user group associated with the respective user persona engaging with the content item and the one or more interactive elements included in the content item.

3. The system of claim 1, wherein the one or more processors, to identify the user persona associated with the content consumer, are configured to:
calculate scores for the plurality of user personas based on the engagement data, each of the scores representing a probability of the content consumer being associated with a subset of the shared attributes associated with the user group corresponding to a respective user persona of the plurality of user personas,
wherein the user persona associated with the content consumer is associated with a highest score, of the scores calculated for the plurality of user personas.

4. The system of claim 1, wherein the one or more processors, to adapt the layout associated with the content item based on the user persona, are configured to:
determine, for a current version of the layout associated with the content item, a probability of the content consumer interacting with the one or more interactive elements; and
adjust the layout associated with the content item to place the one or more interactive elements at locations that increase the probability of the content consumer interacting with the one or more interactive elements based on the shared attributes associated with the user group corresponding to the respective user persona.

5. The system of claim 4, wherein the one or more processors are further configured to:
receive, from the second user device, a subsequent request to access the content item; and
serve, to the second user device, the content item in accordance with the adjusted layout.

6. The system of claim 5, wherein the one or more processors are further configured to:
track engagement data that relates to the content consumer associated with the second user device engaging with one or more of the content item or the one or more interactive elements included in the content item based on the adjusted layout; and
reclassify the user persona associated with the content consumer associated with the second user device based on the engagement data associated with the adjusted layout.

7. The system of claim 1, wherein the one or more processors are further configured to:
select targeted content based on the shared attributes associated with the user group that corresponds to the user persona associated with the content consumer; and
serve the targeted content to the second user device.

8. A method for persona-driven automated content engagement, comprising:
receiving, by a content hosting system and from a first user device associated with a content author, a content item that includes one or more interactive elements,
wherein the content item and the one or more interactive elements are associated with a plurality of user personas that each include shared attributes associated with a user group;
serving, by the content hosting system, to a second user device associated with a content consumer, the content item based on a request to access the content item;
tracking, by the content hosting system, engagement data that relates to the content consumer associated with the second user device engaging with one or more of the content item or the one or more interactive elements included in the content item;
identifying, by the content hosting system, among the plurality of user personas associated with the content item and the one or more interactive elements, a user persona associated with the content consumer associated with the second user device based on the engagement data; and
adapting, by the content hosting system, a layout associated with the content item based on the user persona associated with the content consumer associated with the second user device.

9. The method of claim 8, further comprising:
assigning, for each of the plurality of user personas, a respective score to the content item and respective scores to the one or more interactive elements included in the content item based on probabilities of users in the user group associated with the respective user persona engaging with the content item and the one or more interactive elements included in the content item.

10. The method of claim 8, wherein identifying the user persona associated with the content consumer comprises:
calculating scores for the plurality of user personas based on the engagement data, each of the scores representing a probability of the content consumer being associated with a subset of the shared attributes associated with the user group corresponding to a respective user persona of the plurality of user personas,
wherein the user persona associated with the content consumer is associated with a highest score, of the scores calculated for the plurality of user personas.

11. The method of claim 8, wherein adapting the layout associated with the content item based on the user persona comprises:
determining, for a current version of the layout associated with the content item, a probability of the content consumer interacting with the one or more interactive elements; and
adjusting the layout associated with the content item to place the one or more interactive elements at locations that increase the probability of the content consumer interacting with the one or more interactive elements based on the shared attributes associated with the user group corresponding to the respective user persona.

12. The method of claim 11, further comprising:
receiving, from the second user device, a subsequent request to access the content item; and
serving, to the second user device, the content item in accordance with the adjusted layout.

13. The method of claim 12, further comprising:
tracking engagement data that relates to the content consumer associated with the second user device engaging with one or more of the content item or the one or more interactive elements included in the content item based on the adjusted layout; and
reclassifying the user persona associated with the content consumer associated with the second user device based on the engagement data associated with the adjusted layout.

14. The method of claim 8, further comprising:
selecting targeted content based on the shared attributes associated with the user group that corresponds to the user persona associated with the content consumer; and
serving the targeted content to the second user device.

15. (canceled)

16. (canceled)

17. (canceled)

18. (canceled)

19. (canceled)

20. (canceled)

21. A non-transitory computer-readable medium storing a set of instructions, the set of instructions comprising:
one or more instructions that, when executed by one or more processors of a content hosting system, cause the content hosting system to:
receive, from a first user device associated with a content author, a content item that includes one or more interactive elements,
wherein the content item and the one or more interactive elements are associated with a plurality of user personas that each include shared attributes associated with a user group;
serve, to a second user device associated with a content consumer, the content item based on a request to access the content item;
track engagement data that relates to the content consumer associated with the second user device engaging with one or more of the content item or the one or more interactive elements included in the content item;
identify, among the plurality of user personas associated with the content item and the one or more interactive elements, a user persona associated with the content consumer associated with the second user device based on the engagement data; and
adapt a layout associated with the content item based on the user persona associated with the content consumer associated with the second user device.

22. The non-transitory computer-readable medium of claim 21, wherein the one or more instructions further cause the content hosting system to:
assign, for each of the plurality of user personas, a respective score to the content item and respective scores to the one or more interactive elements included in the content item based on probabilities of users in the user group associated with the respective user persona engaging with the content item and the one or more interactive elements included in the content item.

23. The non-transitory computer-readable medium of claim 21, wherein the one or more instructions, that cause the content hosting system to identify the user persona associated with the content consumer, cause the content hosting system to:
calculate scores for the plurality of user personas based on the engagement data, each of the scores representing a probability of the content consumer being associated with a subset of the shared attributes associated with the user group corresponding to a respective user persona of the plurality of user personas,
wherein the user persona associated with the content consumer is associated with a highest score, of the scores calculated for the plurality of user personas.

24. The non-transitory computer-readable medium of claim 21, wherein the one or more instructions, that cause the content hosting system to adapt the layout associated with the content item based on the user persona, cause the content hosting system to:
determine, for a current version of the layout associated with the content item, a probability of the content consumer interacting with the one or more interactive elements; and
adjust the layout associated with the content item to place the one or more interactive elements at locations that increase the probability of the content consumer interacting with the one or more interactive elements based on the shared attributes associated with the user group corresponding to the respective user persona.

25. The non-transitory computer-readable medium of claim 24, wherein the one or more instructions further cause the content hosting system to:
receive, from the second user device, a subsequent request to access the content item; and
serve, to the second user device, the content item in accordance with the adjusted layout.

26. The non-transitory computer-readable medium of claim 21, wherein the one or more instructions further cause the content hosting system to:
select targeted content based on the shared attributes associated with the user group that corresponds to the user persona associated with the content consumer; and
serve the targeted content to the second user device.
